(19) United States
(12) Patent Application Publication
(10) Pub. No.: US 2016/0140613 A1
(43) Pub. Date: May 19, 2016

(54) ADVERTISEMENT PROVIDING SYSTEM AND METHOD THEREOF

(71) Applicant: HYUNDAI MOTOR COMPANY, Seoul (KR)

(72) Inventors: Seon Su KIM, Seongnam-si (KR); Seung Chang PARK, Seoul (KR)

(21) Appl. No.: 14/739,821

(22) Filed: Jun. 15, 2015

(30) Foreign Application Priority Data
Nov. 17, 2014 (KR) 10-2014-0160328

(51) Int. Cl. G06Q 30/02; H04W 4/00; H04L 29/08; G06F 17/30; H04W 4/04; H04W 4/02

(52) U.S. Cl. CPC G06Q 30/0266; H04W 4/046; H04W 4/023; H04L 67/12; G06F 17/30241; G06F 17/3087; H04W 4/005

(57) ABSTRACT

An advertisement providing system may include a telematics terminal and a telematics server. The telematics server may include a communication server configured to perform wireless communication with the telematics terminal; a database server including a map database, a traffic light database, an advertisement database, and a user database; and a processing server configured to determine whether a vehicle is in a stopped state based on vehicle location information, and calculate an expected amount of stopped time of the vehicle based on the vehicle location information and information stored in the database server when the vehicle is in the stopped state. The processing server may search the advertisement database for advertisement information that corresponds to the vehicle location and the expected amount of stopped time, and transmit the advertisement information to the telematics terminal.

### CROSS-REFERENCE TO RELATED APPLICATION

This application claims the benefit of priority to Korean Patent Application No. 10-2014-0160328 filed in the Korean Intellectual Property Office on Nov. 17, 2014, the entire contents of which are incorporated herein by reference.

### TECHNICAL FIELD

The present disclosure relates to an advertisement providing system, and a method thereof. More particularly, the present disclosure relates to an advertisement providing system that can provide a customized advertisement to a user based on an expected stopped time of a vehicle.

### BACKGROUND

Telematics is a term combining telecommunication and informatics, and is defined as a next generation information providing service for a vehicle through a combination of an IT industry, in which wireless communication, a vehicular terminal, contents, and the like are organically connected with each other, and an auto industry.

The telematics technology may collect vehicle information and provide various multimedia services, such as traffic and driving information, emergency situation response information, remote vehicle diagnosis services, and Internet, by using a wireless communication technology and a global positioning system (GPS) technology.

In the case of a conventional advertisement providing system, an advertisement having a preset and fixed time is displayed when a vehicle enters a specific area. Since it is difficult for a driver to perceive the advertisement while the vehicle is running, a driver's attention may be diverted from a driving road when the driver concentrates on the advertisement.

The above information disclosed in this Background section is only for enhancement of understanding of the background of the invention and therefore it may contain information that does not form the prior art that is already known in this country to a person of ordinary skill in the art.

### SUMMARY

The present disclosure has been made in an effort to provide an advertisement providing system that provides a customized advertisement to a driver by calculating an expected stopped time of a vehicle, and a method thereof.

An advertisement providing system according to an exemplary embodiment of the present invention may include a telematics terminal and a telematics server. The telematics server may include: a communication server configured to perform wireless communication with the telematics terminal; a database server including a map database, a traffic light database, an advertisement database, and a user database; and a processing server configured to determine whether a vehicle is in a stopped state based on vehicle location information and calculate an expected amount of stopped time of the vehicle based on the vehicle location information and information stored in the database server when the vehicle is in the stopped state. The processing server may search the advertisement database for advertisement information that corresponds to the vehicle location information and the expected amount of stopped time and transmit the advertisement information to the telematics terminal.

In certain embodiments, the map database may store road information and service provider information. The service provider information may include name information, location information, or service type information of service providers. The traffic light database may store identification information and cycle information of traffic lights. The advertisement database may store advertisement information including the service provider information, playback time information, and advertisement contents. The user database may store an identifier of the telematics terminal.

In certain embodiments, the processing server may be configured to identify a link on which the vehicle is located based on the vehicle location information and the road information, identify a traffic light located on the link, and calculate the expected amount of stopped time of the vehicle based on the cycle information of the traffic light.

In certain embodiments, the processing server may be further configured to statistically calculate the expected stopped time of the vehicle based on vehicle location information received from a plurality of other telematics terminals and the cycle information of the traffic light.

In certain embodiments, the processing server may be configured to search for advertisement information including playback time information that corresponds to the expected amount of stopped time from among advertisement information of service providers located within a set distance from the vehicle location.

In certain embodiments, the processing server may be configured to search the advertisement database for advertisement information that corresponds to the vehicle location, the expected amount of stopped time, and preference information corresponding to the identifier of the telematics terminal stored in the user database.

In certain embodiments, the processing server may be configured to search, from among advertisement information of service providers located within the set distance from the vehicle location, for service-type information that corresponds to preference information corresponding to the identifier of the telematics terminal when the preference information is stored in the user database. In certain embodiments, the telematics terminal may be configured to periodically receive advertisement information from the telematics server, store the advertisement information in a memory, receive the expected time from the telematics server when the vehicle is in the stopped state, and search the memory for advertisement information that corresponds to the expected stopped time.

In certain embodiments, the telematics terminal may include a communication unit, a global positioning system (GPS), a user input unit, an output unit, a memory, and a controller.

In certain embodiments, the communication unit may be configured to transmit and receive a wireless signal to and from a base station, an external terminal, or a server through a wireless network. In certain embodiments, the user input unit may include a touch pad, a key pad, or a jog shuttle.

An advertisement providing method according to an exemplary embodiment of the present invention may include: determining whether a vehicle is in a stopped state based on vehicle location information received from a telematics terminal; identifying a link on which the vehicle is located based on the vehicle location information and road information when the vehicle is in the stopped state; calculating an expected stopped time of the vehicle; searching an advertisement database for advertisement information that corresponds to the vehicle location and the expected amount of stopped time; and transmitting the advertisement information to the telematics terminal. In certain embodiments, the method further includes identifying a traffic light located on the link, and, in the step of calculating an expected amount of stopped time of the vehicle, the expected amount of stopped time is calculated based on the cycle information of the traffic light.

In certain embodiments, in the step of searching the advertisement database for advertisement information that corresponds to the vehicle location and the expected stopped time, the advertisement information may include playback time information that corresponds to the expected amount of stopped time. The searching may be performed among advertisement information of service providers located within a set distance from the vehicle location.

In certain embodiments, the advertisement providing method may further include: determining whether preference information that corresponds to an identifier of the telematics terminal is stored in a user database; and searching the advertisement database for advertisement information that corresponds to the vehicle location, the expected amount of stopped time, and the preference information when the preference information is stored in the user database.

In certain embodiments, in the step of searching the advertisement database for advertisement information that corresponds to the vehicle location, the expected amount of stopped time, and the preference information, advertisement information including playback time information that corresponds to the expected amount of stopped time and service-type information that corresponds to the preference information is searched from among advertisement information of service providers located within a set distance from the vehicle location.

As described above, according to an exemplary embodiment of the present invention, a customized advertisement that corresponds to the vehicle location, the expected stopped time, and, in certain embodiments, fields of interest may be provided to the driver in the state in which the vehicle is in the stopped state.

### BRIEF DESCRIPTION OF THE DRAWINGS

FIG. 1 is a network diagram illustrating a configuration of an advertisement providing system according to an exemplary embodiment of the present invention.

FIG. 2 is a block diagram illustrating a telematics terminal according to an exemplary embodiment of the present invention.

FIG. 3 is a flowchart illustrating an advertisement providing method according to an exemplary embodiment of the present invention.

### DETAILED DESCRIPTION OF THE EMBODIMENTS

Exemplary embodiments of the present invention will be described more fully hereinafter with reference to the accompanying drawings. As those skilled in the art would realize, the described embodiments may be modified in various different way, all without departing from the spirit or scope of the present invention.

Since each component shown in the drawings is arbitrarily illustrated for easy description, the present invention is not particularly limited to the components illustrated in the drawings.

In the specification, a “node” means a network element corresponding to a point on an actual road. In certain embodiments, the node may be a crossroad. In the specification, a “link” is a network element indicating a connection section in an actual road, which is a connection section between nodes, and includes a start node and an end node.

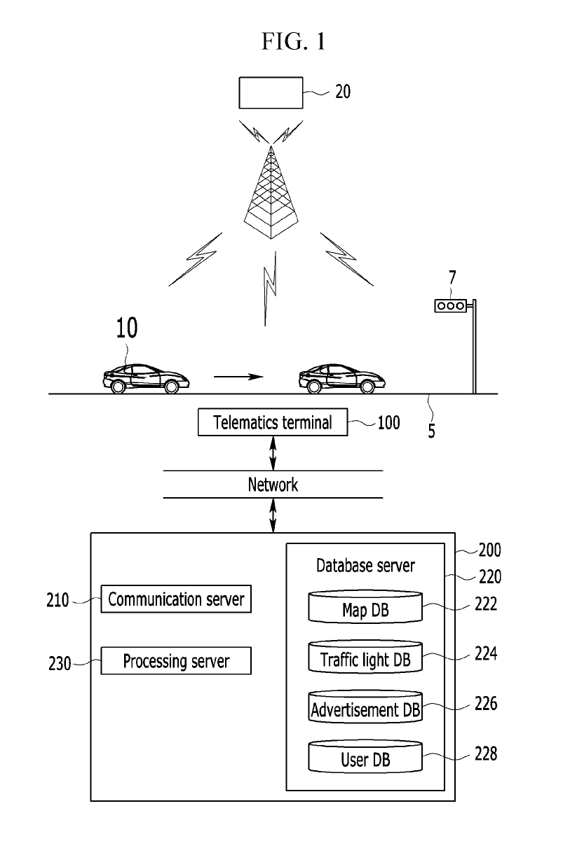

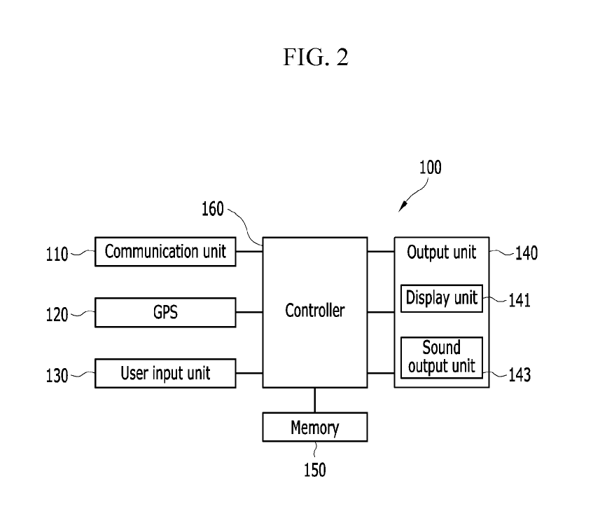

FIG. 1 is a network diagram illustrating a configuration of an advertisement providing system according to an exemplary embodiment of the present invention, and FIG. 2 is a block diagram illustrating a telematics terminal according to an exemplary embodiment of the present invention.

As shown in FIG. 1 and FIG. 2, an advertisement providing system according to an exemplary embodiment of the present invention may include a telematics terminal 100 and a telematics server 200. In certain embodiments, the telematics terminal 100 may be provided in a vehicle 10, and the telematics server 200 may be provided in a telematics center 20.

In certain embodiments, telematics terminal 100 may include a communication unit 110, a global positioning system (GPS) 120, a user input unit 130, an output unit 140, a memory 150, and a controller 160.

In certain embodiments, the communication unit 110 may transmit and receive a wireless signal to and from at least one of a base station, an external terminal, and a server through a wireless network. In particular, the telematics terminal 100 may transmit and receive information to and from the telematics server 200 through the wireless network.

In certain embodiments, the GPS 120 may receive GPS signals from three or more artificial satellites, and calculate a vehicle location. The vehicle location may include information about coordinates indicated with latitude and longitude. In addition, a vehicle speed may be calculated based on the GPS signal.

In certain embodiments, the user input unit 130 may generate input data for controlling an operation of the telematics terminal 100 by a user such as a driver. In certain embodiments, the user input unit 130 may include a touch pad, a key pad, a jog shuttle, and the like. Particularly, when the touch pad and a display unit 141, which will be described below, form a layer structure, the touch pad may be called a touch screen. The driver may set a route by selecting a destination through the user input unit 130.

In certain embodiments, the output unit 140 may generate an output related to a visual or auditory sense, and may include the display unit 141 and a sound output unit 143.

In certain embodiments, the display unit 141 may display information processed by the telematics terminal 100. For example, when the telematics terminal 100 is providing an advertisement, the display unit 141 displays a user interface (UI) or a graphics user interface (GUI) related to provision of the advertisement, and when the telematics terminal 100 is guiding the route, the display unit 141 displays a UI or a GUI related to the route guidance. In certain embodiments, the sound output unit 143 may output audio data received from the communication unit 110 or stored in the memory 150. The sound output unit 143 may output a sound signal related to a function (e.g., the provision of the advertisement and the route guidance) performed by the telematics terminal 100.

In certain embodiments, the memory 150 may store a predetermined program for an operation of the controller 160 and temporarily store input/output data. In addition, the memory 150 may store advertisement information for providing the advertisement, map information for guiding the route, and the like.

In certain embodiments, the controller 160 may control an operation of the telematics terminal 100, and may be implemented with one or more microprocessors executed by a predetermined program. The predetermined program may include a series of commands for performing each step included in an advertisement providing method according to an exemplary embodiment of the present invention described below.

In certain embodiments, the telematics server 200 may include a communication server 210, a database server 220, and a process server 230.

In certain embodiments, the communication server 210 may transmit and receive a wireless signal to and from at least one of a base station, an external terminal, and a server through a wireless network. In particular, the telematics server 200 may transmit and receive information to and from the telematics terminal 100 through the wireless network.

In certain embodiments, the database server 220 may include a map database 222, a traffic light database 224, an advertisement database 226, and a user database 228.

In certain embodiments, the map database 222 may store road information and service provider information. The road information may include node location information, link location information, and connectivity information between nodes and links. The service provider information may include name information of service providers, location information of service providers, service-type information of service providers, and the like. The service-type information may be that of a restaurant, a shopping mall, and the like.

In certain embodiments, the traffic light database 224 may store identification information of traffic lights and cycle information of the traffic lights. In order to identify traffic lights located on each link, identifiers are allocated to each traffic light. The cycle information refers to a cycle during which a traffic light maintains a current display state. For example, in certain embodiments, if the traffic light is configured by a green light, a yellow light, and a red light, the cycle of the green light may be one minute, the cycle of the yellow light may be five seconds, and the cycle of the red light may be one minute. In certain embodiments, the yellow light may be displayed when one minute has elapsed after the green light is displayed, and the red light may be displayed when five seconds has elapsed after the yellow light is displayed.

In certain embodiments, the advertisement database 226 stores advertisement information registered by advertisement providers. The advertisement information may include playback time information, advertisement contents (e.g., text, a still image, a motion image, speech, or a combination thereof), and service provider information including location information of the service providers and service-type information of the service providers. The location information refers to a location of a service provider that provides a service (or product) included in the advertisement content. The service-type information refers to a type of a service (or product) included in the advertisement content. The playback time information refers to a display time of the advertisement content.

In certain embodiments, an identifier of the telematics terminal 100 and driver information that correspond to the identifier of the telematics terminal 100 may be stored in the user database 228. The driver information may include gender information, age information, and preference information. The preference information refers to information on fields of interest registered by the driver. For example, the driver may register the fields of interest such as “Japanese restaurant” and “mountain-climbing equipment retail store” through the telematics terminal 100.

In certain embodiments, the processing server 230 may calculate an expected stopped time of the vehicle 10 based on information received from the telematics terminal 100 and information stored in the database server 220. In certain embodiments, the processing server 230 may identify a link 5 at which the vehicle 10 is located based on the vehicle location information received from the telematics terminal 100 and the road information, and identify a traffic light 7 located on the link 5. In certain embodiments, the processing server 230 may calculate the expected stopped time of the vehicle 10 based on the cycle information of the traffic light 7. Alternatively, in certain embodiments, the processing server 230 may statistically calculate the expected stopped time of the vehicle 10 based on vehicle location information received from a plurality of other telematics terminals and cycle information of the traffic light 7 stored in the traffic light database 224. In certain embodiments, the processing server 230 may calculate the expected stopped time of the vehicle 10 based on stopping factors other than a traffic light. The vehicle location information received from the plurality of other telematics terminal is accumulated in the database server 220.

In certain embodiments, the processing server 230 may search for the advertisement information that corresponds to the vehicle location and the expected stopped time. In particular, the processing server 230 may search for the advertisement information including playback time information that corresponds to the expected stopped time from among advertisement information of service providers located within a predetermined distance from the vehicle location. For example, if the expected stopped time is 30 seconds, the processing server 230 may search for advertisement information of which the playback time is within 30 seconds.

In addition, in certain embodiments, the processing server 230 may search for an advertisement that corresponds to the vehicle location, the expected stopped time, and the preference information. In certain embodiments, the processing server 230 may search for advertisement information including playback time information that corresponds to the expected stopped time and service-type information that corresponds to the preference information from among advertisement information of service providers located within the predetermined distance from the vehicle location. For example, if the expected stopped time is 30 seconds and the preference information corresponds to “Japanese restaurant”, the processing server 230 may search for advertisement information of which the playback time is within 30 seconds and the service type is “Japanese restaurant”.

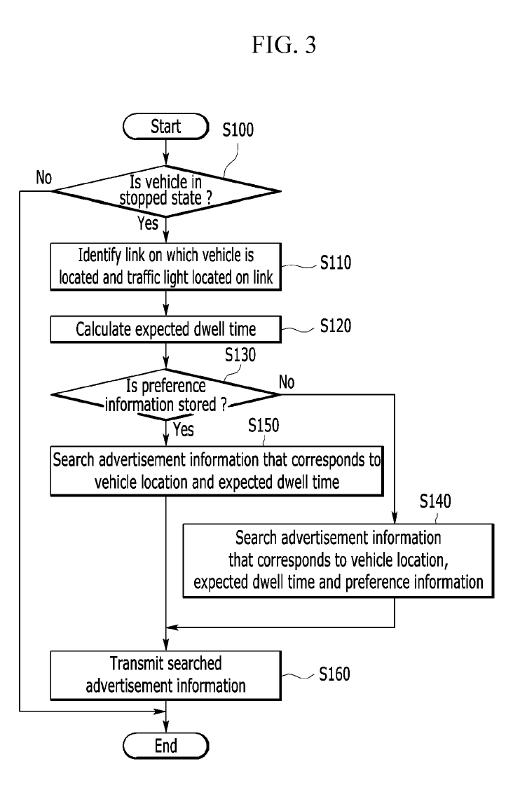

Hereinafter, an advertisement providing method according to an exemplary embodiment of the present invention will be described in more detail with reference to FIG. 3.

Referring to FIG. 3, the processing server 230 determines whether the vehicle 10 is in a stopped state based on vehicle location information received from the telematics terminal 100 at step S100.

When the vehicle 10 is not in the stopped state at step S100, the processing server 230 ends the advertisement providing method according to an exemplary embodiment of the present invention.

When the vehicle 10 is in the stopped state at step S100, the processing server 230 identifies the link 5 on which the vehicle 10 is located based on the vehicle location information and the road information in step S110. In certain embodiments, the processing server 230 identifies the traffic light 7 located on the link 5 in step S110.

The processing server 230 calculates the expected stopped time of the vehicle 10 in step S120. In certain embodiments, the calculation is based on the cycle information of the traffic light 7 stored in the traffic light database 224 at step S120.

In certain embodiments, the processing server 230 determines whether preference information that corresponds to the identifier of the telematics terminal 100 is stored in the user database 228 at step S130.

In certain embodiments, when preference information that corresponds to the identifier of the telematics terminal 100 is not stored in the user database 228 at step S130, the processing server 230 searches the advertisement database 226 for advertisement information that corresponds to the vehicle location and the expected stopped time at step S140. That is, the processing server 230 may search for the advertisement information including playback time information that corresponds to the expected stopped time from among advertisement information of service providers located within the predetermined distance from the vehicle location.

In certain embodiments, when preference information that corresponds to the identifier of the telematics terminal 100 is stored in the user database 228 at step S130, the processing server 230 searches the advertisement database 226 for advertisement information that corresponds to the vehicle location, the expected stopped time, and the preference information at step S150. That is, the processing server 230 may search for the advertisement information including playback time information that corresponds to the expected stopped time and service-type information that corresponds to the preference information from among advertisement information of service providers located within the predetermined distance from the vehicle location.

The processing server 230 transmits the advertisement information to the telematics terminal 100 through the communication server 210 at step S160. In certain embodiments, the telematics terminal 100 may provide the received advertisement information to the driver through the communication server 210.

Alternatively, in certain embodiments, the telematics terminal 100 may periodically receive advertisement information from the telematics server 200 and store the advertisement information in the memory 150. In this case, the telematics terminal 100 may receive only the expected stopped time from the telematics server 200 when the vehicle is in the stopped state. The telematics terminal 100 may search the memory 150 for advertisement information that corresponds to the expected stopped time and provide the advertisement information to the driver.

According to an exemplary embodiment of the present invention, a customized advertisement that corresponds to the vehicle location, the expected stopped time, and the field of interests may be provided to the driver in the state in which the vehicle 10 is in the stopped state.

While exemplary embodiments of this invention have been described above, it is to be understood that the invention is not limited to the disclosed embodiments, but, on the contrary, is intended to cover various modifications and equivalent arrangements included within the spirit and scope of the appended claims.

What is claimed is:

1. An advertisement providing system comprising a telematics terminal and a telematics server,
wherein the telematics server comprises:
a communication server configured to perform wireless communication with the telematics terminal;
a database server including a map database, a traffic light database, an advertisement database, and a user database; and
a processing server configured to determine whether a vehicle is in a stopped state based on vehicle location information, and calculate an expected amount of stopped time of the vehicle based on the vehicle location information and information stored in the database server when the vehicle in the stopped state,
wherein the processing server searches the advertisement database for advertisement information that corresponds to the vehicle location information and the expected amount of stopped time, and transmits the advertisement information to the telematics terminal.

2. The advertisement providing system of claim 1, wherein the map database stores road information or service provider information, the service provider information including name information, location information, or service type information of service providers,
the traffic light database stores identification information and cycle information of traffic lights,
the advertisement database stores advertisement information including the service provider information, playback time information, or advertisement contents, and
the user database stores an identifier of the telematics terminal.

3. The advertisement providing system of claim 2, wherein the processing server is configured to identify a link on which the vehicle is located based on the vehicle location information and the road information, identify a traffic light located on the link, and calculate the expected amount of stopped time of the vehicle based on the cycle information of the traffic light.

4. The advertisement providing system of claim 3, wherein the processing server is further configured to statistically calculate the expected amount of stopped time of the vehicle based on vehicle location information received from a plurality of other telematics terminals and the cycle information of the traffic light.

5. The advertisement providing system of claim 2, wherein the processing server is configured to search for advertisement information including playback time information that corresponds to the expected amount of stopped time from among advertisement information of service providers located within a set distance from the vehicle location.

6. The advertisement providing system of claim 2, wherein the processing server is configured to search the advertisement database for advertisement information that corresponds to the vehicle location, the expected amount of stopped time, and preference information corresponding to the identifier of the telematics terminal stored in the user database.

7. The advertisement providing system of claim 5, wherein the processing server is configured to search, from among advertisement information of service providers located within the set distance from the vehicle location, for service-type information that corresponds to preference information corresponding to the identifier of the telematics terminal when the preference information is stored in the user database.

8. The advertisement providing system of claim 1, wherein the telematics terminal is configured to periodically receive advertisement information from the telematics server, store the advertisement information in a memory, receive the expected amount of time from the telematics server when the vehicle is in the stopped state, and searches the memory for advertisement information that corresponds to the expected amount of stopped time.

9. The advertisement providing system of claim 1, wherein the telematics terminal comprises:
a communication unit;
a global positioning system (GPS);
a user input unit;
an output unit;
a memory; and
a controller.

10. The advertisement providing system of claim 9, wherein the communication unit is configured to transmit and receive a wireless signal to and from a base station, an external terminal, or a server through a wireless network.

11. The advertisement providing system of claim 9, wherein the user input unit comprises a touch pad, a key pad, or a jog shuttle.

12. An advertisement providing method, comprising:
determining whether a vehicle is in a stopped state based on vehicle location information received from a telematics terminal;
identifying a link on which the vehicle is located based on the vehicle location information and road information when the vehicle is in the stopped state;
calculating an expected amount of stopped time of the vehicle;
searching an advertisement database for advertisement information that corresponds to the vehicle location and the expected amount of stopped time; and
transmitting the advertisement information to the telematics terminal.

13. The advertisement providing method of claim 12, further comprising:
identifying a traffic light located on the link;
wherein, in the step of calculating an expected amount of stopped time of the vehicle, the expected amount of stopped time of the vehicle is calculated based on cycle information of the traffic light.

14. The advertisement providing method of claim 12, wherein,
in the step of searching the advertisement database for advertisement information that corresponds to the vehicle location and the expected amount of stopped time, the advertisement information includes playback time information that corresponds to the expected amount of stopped time, and the searching is performed among advertisement information of service providers located within a set distance from the vehicle location.

15. The advertisement providing method of claim 12, further comprising:
determining whether preference information that corresponds to an identifier of the telematics terminal is stored in a user database; and
searching the advertisement database for advertisement information that corresponds to the vehicle location, the expected amount of stopped time, and the preference information when the preference information is stored in the user database.

16. The advertisement providing method of claim 15, wherein,
in the step of searching the advertisement database for advertisement information that corresponds to the vehicle location, the expected amount of stopped time, and the preference information,
advertisement information including playback time information that corresponds to the expected amount of stopped time and service-type information that corresponds to the preference information is searched from among advertisement information of service providers located within a set distance from the vehicle location.
